(19) United States
(12) Patent Application Publication
(10) Pub. No.: US 2003/0016112 A1
(43) Pub. Date: Jan. 23, 2003

(54) Inductive component made with circular development planar windings

(76) Inventor: Davide Brocchi, Prato (IT)

Correspondence Address: Mark J. Patterson, NatinonsBank Plaza, Suite2020, 414 Union Street, Nashville, TN, 37219, US

(21) Appl. No.: 10/176,365

(22) Filed: Jun. 20, 2002

(30) Foreign Application Priority Data
Jun. 21, 2001 (EP) 01830419.6

(51) Int. Cl. H01F 5/00

(52) U.S. Cl. 336/200

(57) ABSTRACT

Described herein is a winding formed by a continuous laminar conductor (11), which, when laid out, presents a generally serpentine pattern consisting of a plurality of loops, and which is bent to bring the loops to overlap one another to form the turns of the winding. The loops are made up of annular sectors (13) intersecting in pairs along a chord (C′) common to the two consecutive annuli. At the chords, the laminar conductor is bent in such a way that the loops overlap one another to form the turns of the winding.

### APPLICATION FOR UNITED STATES LETTERS PATENT

This application claims benefit under 35 U.S.C. 119 (a) of co-pending European Application Serial No. 01830419.6 filed Jun. 21, 2001, in the European Patent Office, entitled “Circular-development planar windings and inductive component made with one or more of said windings” which is hereby incorporated by reference.

The present invention relates to a planar winding, i.e., a winding made with a laminar metal conductor.

Windings of the above type are commonly used in the electronics sector for making inductance coils or other inductive components, for instance transformers, and replace traditional windings made with circular-section metal wires. The aforesaid windings and the corresponding components made therewith present a series of advantages, such as the small size and an improved heat exchange, which facilitates the dissipation of the heat generated by the Joule effect within the component.

From U.S. Pat. No. 4,959,630 and U.S. Pat. No. 5,017,902, planar transformers are known which use windings of this type and which comprise a primary winding with turns formed by a continuous laminar conductor that presents, when disposed in a plane (i.e., prior to bending to form the winding), a serpentine pattern. The secondary winding is made up of a series of lengths of laminar conductor, each of which forms a pair of turns of the secondary winding. These transformers are complex to assemble and are cumbersome. The turns of the primary and secondary windings are interleaved, and their shape is such that, when bent, the overall dimensions of the turns are relatively extensive and irregular.

From U.S. Pat. No. 5,010,314 a planar transformer is known which is made up of a primary winding and a secondary winding, which are both formed by turns made of sheets of conductive material. The various turns are made starting from separate sheets, and thus must subsequently be soldered together or, in any case, connected electrically to obtain continuous windings. The manufacture of these transformers is complex and costly.

The object of the present invention is to provide a planar winding, i.e., one made from a laminar conductor, which is easy to produce and which has small overall dimensions and is regular in order to facilitate its insertion into an inductive component, such as a transformer.

The above and further objects and advantages, which will appear clearly to persons skilled in the art from the ensuing text, are basically obtained with a winding formed by a continuous laminar conductor which, when disposed in a plane, presents a generally serpentine pattern consisting of a plurality of loops and which is bent to bring said loops to overlap one another to form the turns of said winding, and in which the loops are formed by sectors of annuli which intersect one another in pairs along a chord that is common to the two consecutive annuli, the laminar conductor being bent, in a position corresponding to said chord, in such a way that said loops overlap and form the turns of the winding. In this way, the total space occupied by the winding, in plan view, is roughly cylindrical, and the winding can be easily accommodated in a cylindrical container without any waste of space. The assembly is simplified, and there is a reduction in the amount of material used.

In practice, it is advantageous for the continuous laminar conductor to have a substantially constant cross section, the aforesaid chords along which the successive loops intersect having a length roughly equal to the width of the sectors of annuli forming said loops. It is understood that deviations of the length of the chords with respect to the width of the laminar conductor are possible, provided that they are not excessively large, for example contained within ±20%, and preferably within ±15%, or even more preferably within ±10%, of the width of the laminar conductor. Preferably the length of the chord is slightly greater than the width of the laminar conductor in order to compensate for the greater electrical resistance of the region of bending of the conductor. Consequently, the deviation of the length of the chord with respect to the width of the conductor is preferably between +5% and +20%.

Each sector of annulus can have a development according to an arc which extends from one to the other of the two chords along which the laminar conductor is bent. This development defines the electrical path of the turn. Proceeding beyond the aforesaid chords of the annular sector is not necessary for the purposes of passage of the current; however, according to a preferred embodiment of the invention, it is possible to envisage that the annular sectors are also prolonged beyond the chords of intersection, i.e., beyond the lines of bending, and can even come to form a complete annulus, with the exception of an interruption of sufficient size to define a suitable path for the current, i.e., to prevent the turn from being transformed into a closed loop. This added material does not have the purpose of carrying electric current, but prevents areas of air from being formed in the winding, i.e., areas without metal or, in any case, reduces considerably the space where air is present inside the winding. This enables a better thermal transmission, and hence a more efficient dissipation of the heat produced by the Joule effect outside the component in which the winding is inserted.

In order to reduce the axial dimension of the winding, it is expedient for the lines of bending not to overlap one another. For this purpose, the invention envisages a particular distribution of the lines of bending about the axis of the winding, thanks to an appropriate reciprocal angular position and to an appropriate radial dimension of the individual loops.

Forming the subject of the present invention is also an inductive component, for example an inductance coil or a transformer, comprising one or more of the windings defined above. Further advantageous characteristics and embodiments of the windings, the inductive components and the transformers obtained according to the invention are specified in the attached claims.

The invention will be better understood from the ensuing description and the attached drawings illustrating practical, non-limiting, embodiments of the invention. In greater detail:

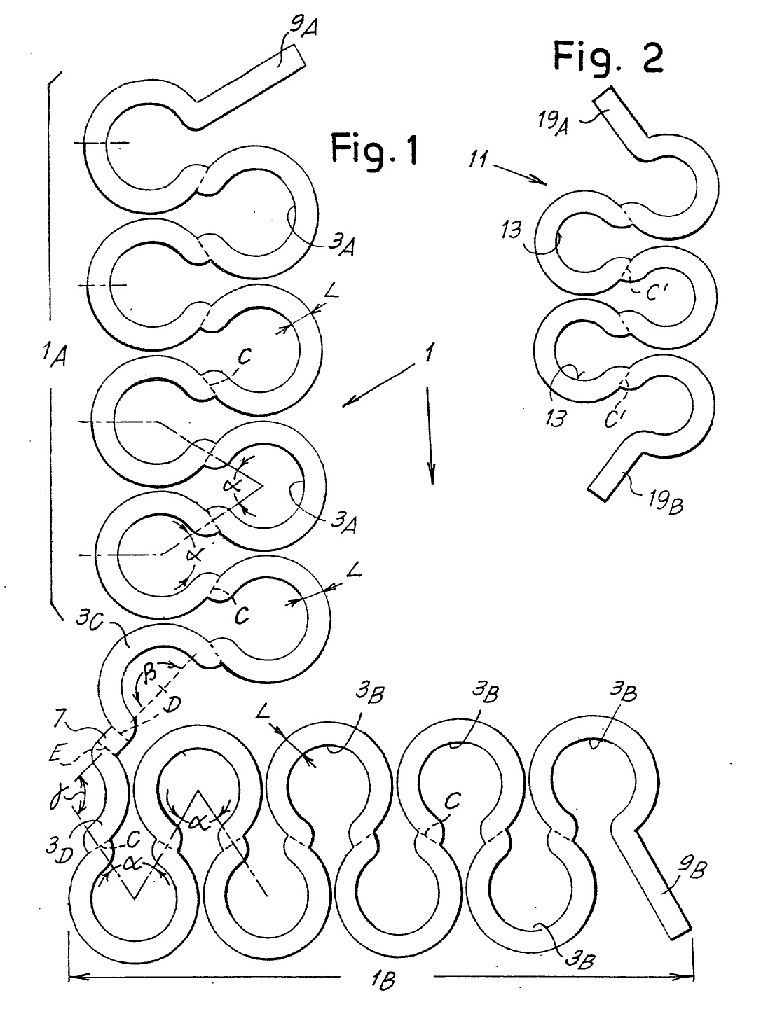

FIG. 1 shows a plane development of the laminar conductor that forms the primary winding in one first embodiment;

FIG. 2 shows a plane development of the laminar conductor that forms the secondary winding in said first embodiment of the transformer;

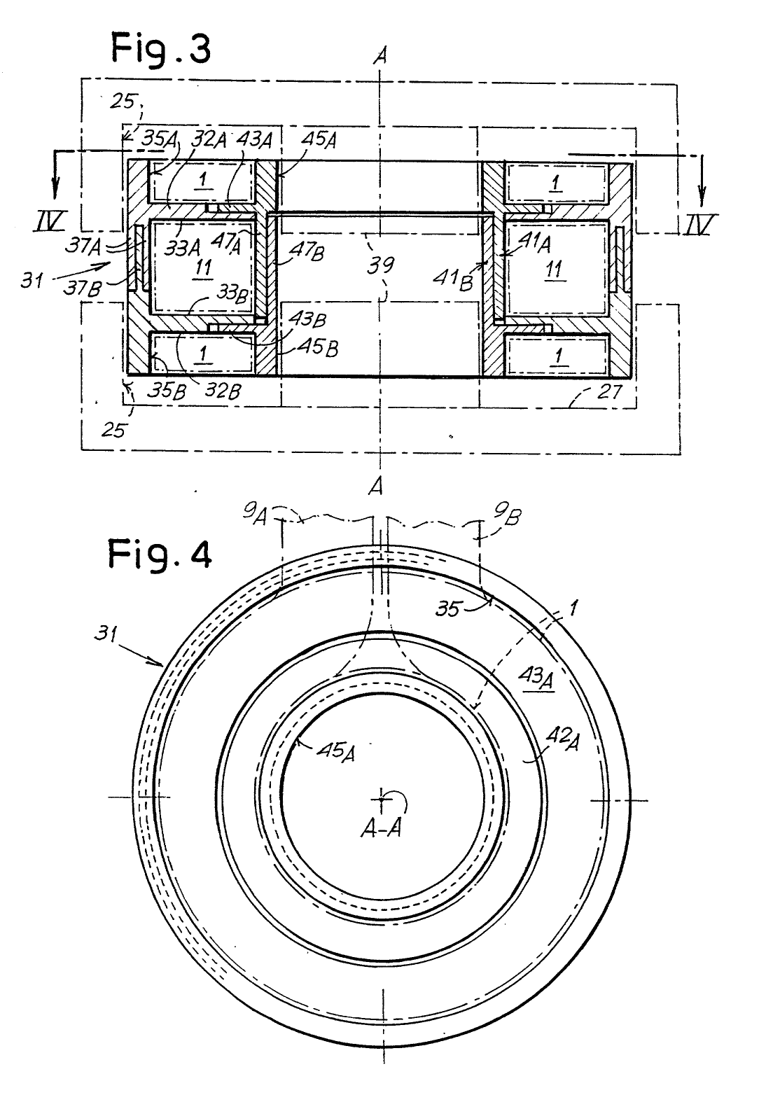

FIG. 3 is a cross-sectional view of the transformer in the assembly step;

FIG. 4 is a cross-sectional view according to the line IV-IV of FIG. 3;

FIG. 5 is a perspective view of the primary winding formed by the laminar conductor of FIG. 1, partially bent,

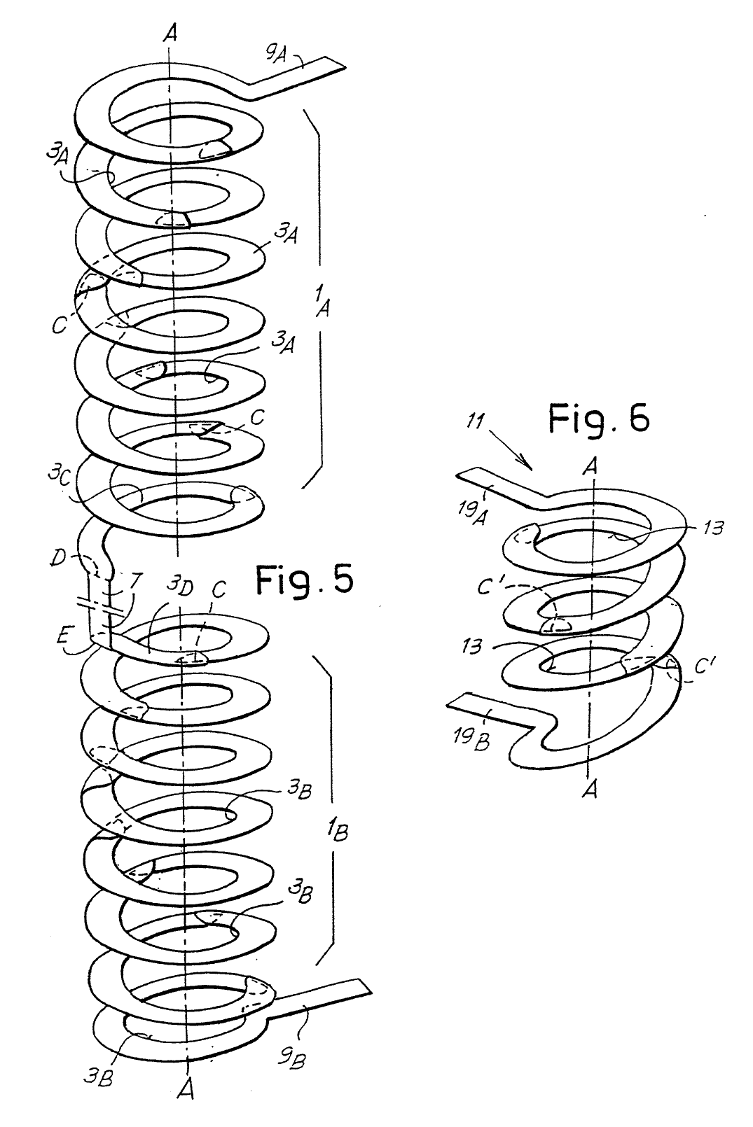

FIG. 6 is a perspective view of the secondary winding formed by the laminar conductor of FIG. 2, partially bent; and

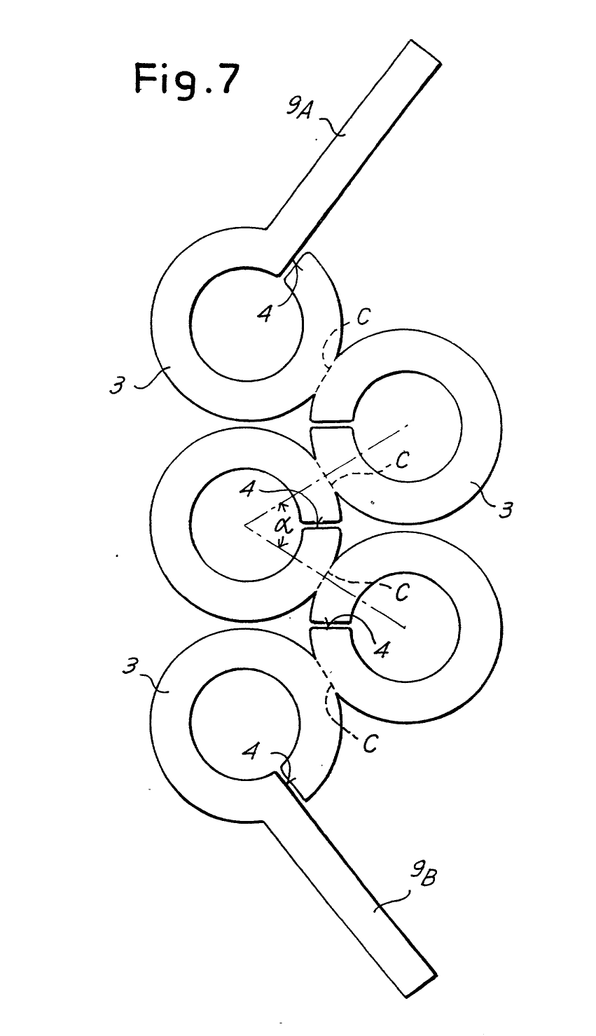

FIG. 7 is a plane development, similar to that of FIG. 2, of a different embodiment of the laminar conductor for formation of the winding.

With reference, first of all, to FIGS. 1 to 6, a planar transformer that uses two windings obtained according to the invention will now be described. It should, however, be understood that the present invention is not limited to the production of planar transformers, in that it also relates more in general to planar windings for making electronic components, even ones with a single winding, for example inductance coils.

FIG. 1 shows the plane development of a first continuous laminar conductor, designated as a whole by 1, which is designed to form a first winding of the transformer, hereinafter conventionally referred to as primary winding. The first conductor 1 presents, in the plane development, i.e., before bending to form the winding, a generally serpentine pattern consisting of a plurality of loops. The loops are divided into a first series of loops, designated as a whole by 1A, and a second series of loops, designated as a whole by 1B. The loops of each of said series, individually designated by 3A and 3B respectively for the two series, consist of portions or sectors of annulus of said continuous laminar conductor. More in particular, the loops 3A, 3B are each made up of portions with an angular development α of approximately 295°.

Contiguous loops intersect one another along respective chords C. The chords C have a length approximately equal to the width L of the laminar conductor, i.e., equal to the difference between the external radius and internal radius of the annuli. Preferably, as mentioned previously, the length of the chords C is slightly greater, and typically from 5% to 20% greater, than the width L of the conductor.

As shown schematically in FIG. 1, the individual loops are rounded off at their ends by appropriate radiusing, which smoothes off the sharp edges that would define the ends of the sectors of annulus, even though this is not absolutely essential.

The series of loops 3A, 3B of the two portions 1A, 1B into which the laminar conductor 1 is divided are joined together in a region of transition or passage from one series to another by means of two partial loops 3C, 3D with angular developments β and γ of approximately 180° and approximately 100°, respectively. The two partial loops 3C, 3D are set at a distance apart and are joined together by an intermediate portion 7 of the continuous laminar conductor. In this way, the two series of loops 3A, 3B develop according to orientations that are substantially perpendicular to one another, with a consequent optimal exploitation of the starting material from which the continuous laminar conductors are made.

The reference numbers 9A and 9B designate two rectilinear end portions of the laminar conductor which form the external connections of the winding.

FIG. 2 shows a second continuous laminar conductor 11 designed to form a second winding of the transformer, hereinafter conventionally referred to as secondary winding. The same numbers increased by 10 designate parts that are the same as, or correspond to, those of the laminar conductor 1 making up the primary winding. Unlike the primary winding, the secondary winding is not divided into two sets of turns, and hence the pattern of the plane laminar conductor is simpler. On the other hand, it is not to be excluded that also the secondary winding may be configured in a way that is equivalent to the primary winding; i.e., the sets of turns are interspaced. Alternatively, it may be envisaged that also the laminar conductor designed to form the primary winding is made with a single series of loops, instead of two series of loops, in a way similar to that illustrated in FIG. 2 primary winding, providing an adequate number of loops, and hence (after bending) of turns.

The chords along which the sectors of annulus intersect are designated, in this case, by C′. The loops 13 of the second laminar conductor 11 substantially have the same shape as the loops 3A or 3B of the first laminar conductor forming the primary winding.

In order to obtain the primary winding and secondary winding, the two continuous laminar conductors 1 and 11 are bent, respectively, along the chords C and C′, in such a way that the various loops are arranged one on top of the other. The laminar conductor 1 is moreover bent along the lines D and E that join the partial turns 3C and 3D to the intermediate portion 7. The result of these bends is illustrated in FIGS. 5 and 6 for the primary winding and secondary winding, respectively. The primary winding has two sets of turns, again designated by 3A and 3B, consisting of the overlapping of the loops 3A, 3C and 3D, 3B, respectively, which develop about an axis A-A (see in particular FIG. 3). The two sets of turns are joined together by the intermediate portion 7. Between the two sets of turns 3A, 3C and 3D, 3B, the turns formed by the bending of the secondary winding are inserted.

As may be seen in FIGS. 5 and 6, the bends that lead to the overlapping of the successive loops are angularly staggered with respect to one another, and this reduces the overall thickness of the two windings.

The two windings are then assembled in a container made of insulating material set inside a ferrite core or other suitable ferromagnetic material consisting, for example, of two equal portions, as illustrated in FIGS. 3 and 4, and designated therein by 25. It may also be envisaged that the other portion of the ferrite core is formed by a flattened parallelepiped with a shape corresponding to the base of the portion 25.

In the portion 25 there is made a seat 27 for the windings, which surrounds a central body 29 that extends axially inside the primary and secondary windings.

As schematically illustrated in FIGS. 3 and 4, the three sets of turns 3A, 3B and 13 are accommodated in the ferrite core and housed in a container made of insulating material 31, consisting of four elements that form a seat for accommodating the secondary winding formed by the bending and overlapping of the loops 13, whilst the two sets of turns 3A and 3B that form the primary winding are each housed between the respective ferrite portion and a wall of the insulating container 31.

The insulating container 31 is made up of two bodies 33A, 33B with plane walls 32A, 32B and side walls 35A, 35B which extend from said plane walls outwards to delimit externally the seats for the two sets of turns 3A, 3B forming the primary winding. From the opposite surface of the two plane walls 32A, 32B, there extend respective intermediate side walls 37A, 37B shaped so as to be inserted inside one another and delimiting externally the seat for housing the secondary winding. The walls 37A, 37B form an abutment for arranging the two bodies 33A, 33B at the desired distance apart.

In order to separate the central body 29 of the ferrite core there are moreover provided two sleeves 41A, 41B which are inserted in central openings of the plane walls 32A, 32B of the two bodies 33A, 33B, respectively, through which there extends the central body 29 of the ferrite core. The two sleeves 41A, 41B each have a flange 43A, 43B, which is inserted in a lowered seat made on the corresponding outer surfaces of the respective wall 32A, 32B. With respect to the flange 43A, 43B, each sleeve develops with a respective external tubular portion 45A, 45B and with a respective internal tubular portion 47A, 47B. The tubular portions 45A and 45B delimit the seats for the two series of turns of the primary winding, whilst the two internal tubular portions 47A and 47B are inserted inside one another and form a continuous wall delimiting the seat for housing the secondary winding set between the walls 32A, 32B.

The fact that the container 25 is made up of four components means that it is particularly easy to mould, notwithstanding the relatively complex configuration.

The laminar conductors 1 and 11 are appropriately varnished with an insulating varnish and/or are applied on a film of insulating material, in such a way that the turns obtained by bending are electrically insulated from one another. Alternatively, it is possible to set films or sheets of insulating material between the turns and/or between the last turn and the ferromagnetic core.

The two laminar conductors shown in FIGS. 1 and 2 may be obtained by photo-engraving, laser cutting, punching, or with other suitable techniques, from a sheet of copper or other suitable conductive material. The form of the loops is particularly elaborate, and hence more easily obtainable with a process of photo-engraving or by laser cutting than by punching.

The conformation of the first winding, with the portion 7 of joining of the two series of turns, can be made also with different shapes of the loops, and hence of the turns of the laminar conductor, for example with rectangular turns. Also in the latter case, there is the advantage of obtaining a transformer with a first winding made of a continuous conductor but divided into two portions between which is inserted a second winding.

In general, therefore, and regardless of the shape of the turns, it is possible to envisage a transformer comprising at least one first winding and at least one second winding, in which at least said first winding is formed by a first continuous laminar conductor which, when disposed in a plane, presents a generally serpentine pattern consisting of a plurality of loops and which is bent to bring said loops to overlap one another to form the turns of said first winding about an axis, characterized in that said turns of the first winding are divided into at least one first set and one second set of turns, made up, respectively, of one first series of said loops and of one second series of said loops, the two sets of turns being set at a distance apart from one another and being connected by an intermediate portion of said first laminar conductor, said at least one second winding being inserted between said first set of turns and said second set of turns.

FIG. 7 illustrates, in a plane development similar to that of FIG. 1, an alternative and improved embodiment of the laminar conductor for making a winding according to the invention, which may be used for producing an inductive component, for example an inductance coil, or else a transformer. In this embodiment, the laminar conductor 1 has loops, again designated by 3, consisting of complete annuli, except for a radial interruption 4. Basically, then, each loop consists of a sector of annulus of almost 360°. The interruption 4 has a width such that it interrupts the electrical continuity of the annulus. In practice, as compared to the previous example of embodiment, in this case the sectors of annulus proceed beyond the line of bending represented by the common chord C of the adjacent or successive loops to close the annulus almost completely.

The reference numbers 9A and 9B again designate the end portions of the laminar conductor 1 which form the external connections of the winding.

With this configuration. when the loops are bent along the chords or lines of bending C, a distribution of the bends is obtained along the annular development of the winding in a way similar to what was described previously, with a substantial reduction in the overall thickness. In addition, the development in the form of an almost complete annulus of each loop, and hence of each turn, due to the presence of conductive material beyond the lines of bending C, substantially reduces the volume of air in the winding obtained by bending the laminar conductor 1 by filling the space available with the metallic material of the laminar conductor. This enables a better dissipation via thermal transmission through conduction of the heat generated by the Joule effect in the individual turns, and hence a more efficient cooling of the component containing the winding itself.

The winding obtained by bending the laminar conductor 1 of FIG. 7 can be used, for example, as a secondary winding and/or as a primary winding of a transformer by inserting it in a ferromagnetic core which can have the same shape as, or a similar shape to, the one illustrated in FIGS. 3 and 4. It is possible to use an insulating container, such as the one illustrated in the aforesaid figures or some other type. It is clear that the same shape of the loops illustrated in FIG. 7 can be used in a laminar conductor shaped as in FIG. 1, i.e., in which the loops are divided into two sets or groups to form a winding in two portions between which the secondary winding is inserted.

It is understood that the plate of drawings only illustrates, by way of example, practical embodiments of the invention, which may vary in its embodiments and arrangements without thereby departing from the scope of the underlying idea.

1. A winding formed by a continuous laminar conductor which, when disposed in a plane, presents a generally serpentine pattern consisting of a plurality of loops and which is bent so as to bring said loops to overlap one another to form the turns of said winding,
characterized in that said loops are made up of sectors of annulus which intersect one another in pairs along respective chords that are common to the two successive annuli, the laminar conductor being bent, in a position corresponding to said chords, in such a way that said loops overlap one another and form the turns of the winding.

2. The winding according to claim 1, characterized in that said continuous laminar conductor has a substantially constant cross section, said chords along which consecutive loops intersect having a length roughly equal to the width of the annular sectors forming said loops.

3. The winding according to claim 1 or 2, characterized in that said chords have a length that does not go beyond 20%, preferably not beyond 15%, and even more preferably not beyond 10%, with respect to the width of said annuli.

4. The winding according to one or more of the foregoing claims, characterized in that at least some of the annular sectors extend beyond said chords along which the laminar conductor is bent to form the turns of the winding.

5. The winding according to claim 4, characterized in that said annular sectors have a development corresponding to a complete annulus except for a transverse interruption sufficient for electrical interruption of the annulus to form the corresponding turns.

6. The winding according to one or more of the foregoing claims, characterized in that said annular sectors forming the loops of the laminar conductor have internal and external diameters and are set at reciprocal angular positions such that a plurality of said successive chords, along which the laminar conductor is bent in such a way that the consecutive loops overlap one another, come to be angularly staggered about the axis of the winding when said laminar conductor is bent.

7. An inductance coil comprising a winding according to one or more of the foregoing claims.

8. A transformer comprising at least a first and a second winding and a ferromagnetic core defining a magnetic circuit, characterized in that at least said first winding consists of a winding according to any one of claims 1 to 6.

9. The transformer according to claim 8, characterized in that said second winding consists of a further winding according to one or more of claims 1 to 6.

10. The transformer according to claim 8 or 9, characterized in that said turns of the first winding are divided into at least one first set and at least one second set of turns, respectively constituted by a first series of said loops and a second series of said loops, the two sets of turns being at a distance apart from one another and being connected by an intermediate portion of said laminar conductor, said at least one second winding being inserted between said first set of turns and said second set of turns.

11. The transformer according to one or more of claims 8 to 10, characterized in that said first and second series of loops of the laminar conductor forming the first winding each comprise a partial loop having a smaller development than the other loops of the respective series, the two partial loops being contiguous and there being set, between them, said intermediate portion of the laminar conductor.

12. The transformer according to claim 1, characterized in that, when disposed in a plane, said first and second series of turns extend according to two orientations that are mutually orthogonal.
